(19) United States
(12) Patent Application Publication
(10) Pub. No.: US 2005/0138548 A1
(43) Pub. Date: Jun. 23, 2005

(54) Computer aided authoring and browsing of an electronic document

(75) Inventors: Shi Xia Liu, Beijing (CN); Li Ping Yang, Beijing (CN)

Correspondence Address: IBM CORPORATION, T.J. WATSON RESEARCH CENTER, P.O. BOX 218, YORKTOWN HEIGHTS, NY, 10598, US

(73) Assignee: International Business Machines Corporation, Armonk, NY (US)

(21) Appl. No.: 11/014,521

(22) Filed: Dec. 16, 2004

(30) Foreign Application Priority Data
Dec. 17, 2003 (CN) 200310121288.X

(51) Int. Cl. G06F 17/00

(52) U.S. Cl. 715/513

(57) ABSTRACT

Provides methods, apparatus and systems for computer aided authoring, a method for browsing an electronic document, an apparatus for aided authoring and an electronic document browser. Said method for computer aided authoring comprises: generating a structure summary based on said electronic document during a writer is writing the electronic document; and saving the structure summary information in correspondence with said electronic document.

### TECHNICAL FIELD

The present invention relates to data processing technique, in particular, to the technique of computer aided authoring and the corresponding technique for browsing an electronic document.

### TECHNICAL BACKGROUND

In the past, the document writing tools used by a writer are independent from document management and browsing tools; that is, the writer does not care how the readers will leverage the content written by him/her when he/she is preparing it. While at the same time, from the information accessing point of view, users would feel that it is very difficult to know the main content of a document before buying and reading it.

Moreover, at present, the computer's capability to understand natural languages is still at word-level understanding, while for the document previewing, retrieving and management tools, there is a need of sentence and document level understanding together with semantic capability so as to really satisfy users' requirements. Consequently, according to the present speed of technical development, it is believed that the existing technology on document writing, previewing, and management will not evolve to meet the requirements of users in the near future.

### SUMMARY OF THE INVENTION

Therefore, in order to solve the above mentioned problems of the prior art, the present invention provides that the writer is enabled to prepare related information, in the process of preparing a document, for subsequent document preview, retrieval and management of the document; that is, the writer is provided with a set of tools to conveniently contribute to users' subsequent searching and retrieving of the document, more particularly, to prepare a structure summary.

According to one aspect of the present invention, there is provided a method of computer aided authoring, comprising: during a writer is writing a document, generating a structure summary based on said document; and saving said structure summary information in correspondence with said electronic document.

According to another aspect of the present invention, there is provided a method for browsing an electronic document, comprising: reading structure summary information saved in correspondence with the electronic document, wherein said structure summary information contains the structure summary of the electronic document; and presenting said structure summary to a user in response to the user's operation.

According to still another aspect of the present invention, there is provided an apparatus for aided authoring, comprising: an electronic document editor for editing an electronic document; a summary generation unit for generating a structure summary based on said electronic document; and a summary saving unit for saving the structure summary information generated by said summary generation unit in correspondence with said electronic document.

According to still another aspect of the present invention, there is provided an electronic document browser, comprising: a structure summary reading unit for reading structure summary information saved in correspondence with said electronic document being browsed, wherein said structure summary information contains a structure summary of the electronic document; and a structure summary presentation unit for presenting the user with the structure summary contained in said structure summary information.

### BRIEF DESCRIPTION OF THE DRAWINGS

The above and other aspects, features, and advantages of the present invention will become more apparent from the following detailed description when taken in conjunction with the accompanying drawings, in which:

FIG. 1 is a flowchart showing a method of computer aided authoring according to an embodiment of the present invention;

FIGS. 2A and 2B are detailed flowcharts showing a method of computer aided authoring according to an embodiment of the present invention;

FIG. 3 is a block diagram illustrating the structure of an apparatus for aided authoring according to an embodiment of the present invention; and

FIG. 4 is a block diagram illustrating the structure of an electronic document browser according to an embodiment of the present invention.

### DETAILED DESCRIPTION OF THE INVENTION

In order to solve the above mentioned problems of the prior art, the present invention provides that the writer is enabled to prepare related information, in the process of preparing a document, for subsequent document preview, retrieval and management of the document; that is, the writer is provided with a set of tools to conveniently contribute to users' subsequent searching and retrieving of the document, more particularly, to prepare a structure summary.

The present invention, provides a method of computer aided authoring, comprising: during a writer is writing a document, generating a structure summary based on said document; and saving said structure summary information in correspondence with said electronic document.

The present invention, provides a method for browsing an electronic document, comprising: reading structure summary information saved in correspondence with the electronic document, wherein said structure summary information contains the structure summary of the electronic document; and presenting said structure summary to a user in response to the user's operation.

The present invention, provides an apparatus for aided authoring, comprising: an electronic document editor for editing an electronic document; a summary generation unit for generating a structure summary based on said electronic document; and a summary saving unit for saving the structure summary information generated by said summary generation unit in correspondence with said electronic document.

The present invention, provides an electronic document browser, comprising: a structure summary reading unit for reading structure summary information saved in correspondence with said electronic document being browsed, wherein said structure summary information contains a structure summary of the electronic document; and a structure summary presentation unit for presenting the user with the structure summary contained in said structure summary information.

Next, detailed description is given to advantageous embodiments of the present invention with reference to the drawings.

Method of Computer Aided Authoring

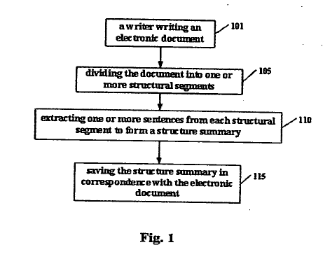

According to one aspect of the present invention, there is provided a method of computer aided authoring. FIG. 1 is a flowchart showing the method of computer aided authoring according to an embodiment of the present invention. As shown in FIG. 1, first at step 101, a writer writes an electronic document. Usually, generation of a structure summary is performed after the writer has completed a document. Of course, generation of a structure summary may also be performed when a portion of a document (such as a chapter) has been completed according to the actual situation.

Next, at step 105, the document is divided into one or more structural segments. Each structural segment is related to a topic. Usually, one document (such as an article) would discuss one main topic, but the main topic is often expanded to a plurality of different topics/subtopics to be discussed in different structural segments. This step is to divide the document into a plurality of structural segments according to the involved topics respectively. Particularly, the structural segments may be assigned by the writer manually or be divided automatically (detailed description will be given hereafter).

Next, at step 110, one or more sentences are extracted from each structural segment respectively to form a structure summary. Thus, it is ensured that the structure summary will reflect the content of respective topics of the entire document.

Next, at step 115, the structure summary is saved in correspondence with the electronic document. The present invention is not limited to a specific way in which the structure summary information is saved, for instance, it may be saved together with the electronic document, that is, as a part of the electronic document, or may be saved separately, as long as it is saved in correspondence with the electronic document.

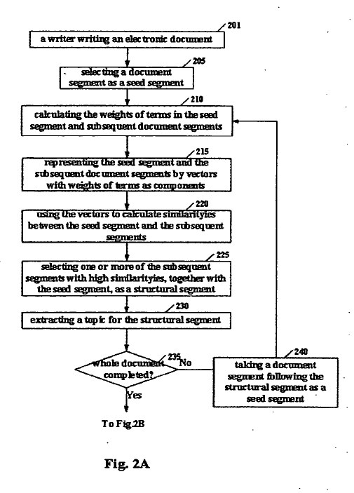

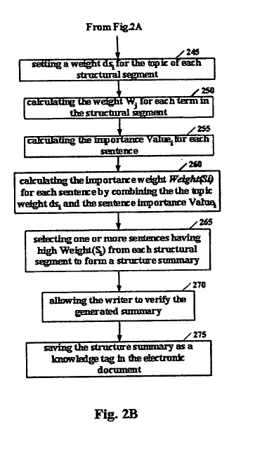

Next, the method of computer aided authoring of the present invention will be further explained in conjunction with FIG. 2. FIGS. 2A and 2B are detailed flowcharts showing the method of computer aided authoring according to an embodiment of the present invention.

As shown in FIG. 2A, first at step 201, the writer writes an electronic document. Next, at step 205, a document segment is selected as a seed paragraph. Depending on actual scenario, a document segment may be a natural paragraph, a sentence or a part of a sentence. In this example, it is assumed that a document segment is a natural paragraph in the document. Generally, the document segment at the beginning of a document is selected as the first seed paragraph.

Next, at step 210, the weights of the terms in the seed paragraph and in the subsequent document paragraphs are calculated. Here, terms refer to the words remained in the text after removing the stop words. For instance, but not limited to, the tf−idf method may be used to calculate the weight of each term, that is, the weight of each term is: tf×idf, where tf is the frequency (times) of occurrence of the term in the document paragraph, idf=all_segments/term_segements, here all_segments is the number of all document paragraphs in the document, term_segments is the number of document paragraphs in which the term is contained. Weights of terms calculated in this way will lead to a result that a term with high occurrence frequency in a document paragraph would have a large weight and a term that appears in a wide range of the whole document would have a small weight.

Next, at step 215, the seed paragraph and the subsequent document paragraphs are represented by vectors with the weights of the terms as their components, respectively. For instance, but not limited to, the vectors of the seed paragraph and the subsequent i-th paragraph are respectively as:
S=(s₁,s₂, . . . ,sₙ)
Pᵢ=(wᵢ₁,wᵢ₂, . . . ,wᵢₙ)

Herein, for the purpose of convenience in subsequent calculation, the dimensions of these vectors are set to the same and the components representing respective terms would correspond to each other.

Next, at step 220, the similarity between the seed paragraph and each subsequent paragraph is calculated by using the above-mentioned vectors. Particularly, the angle between the vector of the seed paragraph and the vector of a subsequent document paragraph may reflect the similarity between these two segments. Thus, usually the cosine of the angle between them may be used as a measure of similarity, that is,
similarity(S,Pᵢ)=cos(S,Pᵢ).

Next, at step 225, one or more subsequent segments with high similarity are selected, together with the seed segment, as a structural segment. Particularly, a threshold may be predetermined. If the similarity between the seed segment and a subsequent segment is larger than the threshold, the subsequent segment is considered to belong to the same structural segment as the seed segment, otherwise the segment would not belong to the structural segment. Further, preferably, the document segments between the document segment of high similarity and the seed segment are selected as a part of the structural segment. For instance, suppose P₁, P₂ and P₃ are three continuously subsequent document segments, in which the similarity between P₃ and the seed segment is higher than the threshold, then P₁, P₂ and P₃ would all be added to this structural segment. This is based on the assumption that when the writer is writing a document, he will continuously complete one topic/subtopic rather than jump among a plurality of topics.

Next, at step 230, the topic of the structural segment is extracted. Here, this step can be performed by extracting a certain number of terms having the largest weight from the structural segment as the topic of the structural segment based on the weights calculated in the above-mentioned step 210, or through inputting a corresponding topic by the writer.

Next, at step 235, a determination is made as to whether the whole document has been processed. If not, the process proceeds to step 240, taking the document segment following the structural segment as the seed segment and return to step 210 to repeat steps 210 to 235 until the whole document is processed completely. If at the step 235 it is determined that the whole document has been processed, the process will proceed to the step 245 in FIG. 2B.

As shown in FIG. 2B, at step 245, the structure of the document is analyzed to set a weight for each structural segment to indicate its importance. Particularly, the above-mentioned if−idf method may be used to calculate the weights of terms contained in each topic in the range of the whole document, and the sum of the weights of terms in the topic of each structural segment is taken as the weight dsᵢ indicating the importance of the topic.

Next, at step 250, for each sentence in the structural segment, the weight of each term in the sentence is calculated. Particularly, the if−idf method may be used to calculate weight wⱼ for each term:
wⱼ=tf·idf
wherein tf is the occurrence frequency (times) of the term in the sentence, idf=all_sentences/term_sentences, all_sentences is the number of all sentences in the structural segment, term_sentences is the number of the sentences in which the term is contained. Weights of terms calculated in this way will lead to a result that a term in the sentence with high occurrence frequency would have a large weight and a term that appears in a wide range of the whole document would have a small weight.

Next, at step 255, for each sentence in the structural segment, the importance, valueᵢ is calculated. Particularly, valueᵢ may be the sum of the weights of all terms contained in the sentence, that is:

$${value}_{i} = {\sum }_{{w}_{j} ∈ {S}_{i}} {w}_{j}$$

Next, at step 260, combining the topic weight dsᵢ and the sentence importance valueᵢ calculated above, the importance weight weight(Sᵢ) is calculated, for instance, by using following formula:
weight(Sᵢ)=dsᵢ·valueᵢ

Next, at step 265, one or more sentences with highest importance weight value weight(Sᵢ) are selected from each structural segment, forming a structure summary. Preferably, at least one sentence should be selected from each structural segment.

Next, at step 270, the writer is allowed to verify the generated structure summary. Here, the “verification” includes the writer's reviewing and modifying the generated structure summary, so as to ensure that the final structure summary can reflect the content of the document accurately and completely and has good readability.

Then at step 275, the structure summary is saved as a knowledge tag together with the electronic document. For instance, a knowledge tag is appended at the end of the electronic document:

```
<StructureSummary>
  Yao Ming scored all 18 of his points in the first half and reserve Maurice Taylor had 11 of
  his 17 points in the fourth quarter in the Houston Rockets' 105-90 victory over the Los
  Angeles Clippers 105-90 Monday night.
  Kobe Bryant scored 28 points, Karl Malone had 20 points and 10 rebounds and Gary Payton added 17
  points and 10 assists to lead the Los Angeles Lakers to a 121-89 drubbing of the Memphis Grizzlies on
  Sunday night.
  ......
</ StructureSummary >
```

Alternatively, it is also possible to define a tag type for the knowledge tag of the structure summary at the header of an electronic document, and in the text of the electronic document, the tag is used to indicate the sentences to be included in the summary.

Furthermore, preferably, after the segmentation of the structural segments and/or after the extraction of the topic of structural segments, the writer may also be allowed to join in verification. For instance, the writer may change the segmentation of structural segments and specify a more reasonable topic according to his own understanding (writing intention), so as to complete the preparation of the structure summary through timely and effective human-machine interaction.

From the above description it can be seen that the method of computer aided authoring according to the present invention can assist the writer to complete the preparation of the structure summary without bringing too much burden to the writer. The understanding of the writer to the document (which is definitely the most accurate understanding) can be utilized to ensure the accuracy and readability of the structure summary generated. And because the generated structure summaries can reflect the contents of respective parts of a document, the user can find out the main content of the document more accurately and completely when the structure summary information is used for previewing, so that high degree of user satisfaction can be obtained.

Method for Browsing an Electronic Document

Under the same inventive conception, according to another aspect of the present invention, there is provided a method for browsing an electronic document, the electronic document is generated through the above described method of computer aided authoring, that is, the structure summary information has been saved in correspondence with the document.

The method for browsing an electronic document of the present invention is different from existing techniques in that the method includes:
(1) reading the structure summary information saved in correspondence with the electronic document, wherein the structure summary information contains the structure summary of the electronic document. Particularly, the structure summary information is read out according to the way in which the structure summary information is saved. For instance, if the structure summary information is saved as a knowledge tag at the end of the document, then the corresponding knowledge tag is identified and the information in it is read out; and
(2) in response to the user's operation, presenting the user with said structure summary. If the user wants to view the structure summary of the document, the read-out structure summary can be presented to the user for browsing, for instance, through an operation, such as clicking a menu or button.

From the above-description of the present embodiment it can be seen that, if the method for browsing an electronic document of the present embodiment is implemented, by means of the structure summary information in an electronic document generated by the above mentioned method of computer aided authoring, it is possible to present the reader with the structure summary verified by the writer, so as to let the reader learn the rough structure and content of the document, whereby saving the reader's time for reading.

Apparatus for Aided Authoring

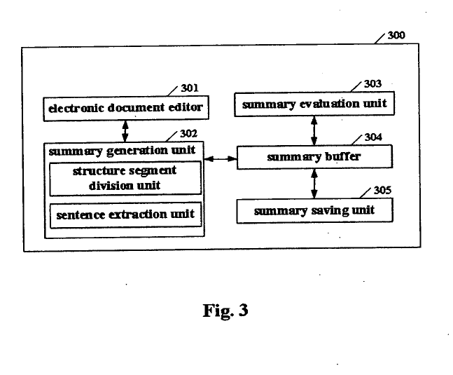

Under the same inventive conception, according to another aspect of the present invention there is provided an apparatus for aided authoring. FIG. 3 is a block diagram illustrating the structure of the aided authoring apparatus according to an embodiment of the present invention.

As shown in FIG. 3, the aided authoring apparatus 300 comprises: an electronic document editor 301 for editing an electronic document, which may be an independent document editor, or an shared existing document editor, such as MS Word, WPS or the like; a summary generation unit 302 for generating a structure summary according to the electronic document; a summary saving unit 305 for saving the structure summary information generated by the summary generation unit 302 in correspondence with the electronic document; a summary evaluation unit 303 for allowing the writer to evaluate and modify the structure summary generated by the summary generation unit 302; and a summary buffer 304 for temporarily storing the structure summary generated by the summary generation unit 302.

Therein, the summary generation unit 302 may further comprise: a structural segment division unit for dividing said document into one or more structural segments, each said structural segment relates to a topic; and a sentence extraction unit for extracting one or more sentences from each of said structural segments divided by said structural segment division unit, respectively, to form a structure summary.

Furthermore, the aided authoring apparatus 300 may further comprise: a similarity calculation means for calculating the similarity between document segments. The structural segment dividing unit of the summary generation unit 302 uses said similarity calculation means to calculate the similarity between document segments, thereby selecting one or more document segments with high similarity as one structural segment.

Furthermore, as described above, the similarity calculation means may calculate the similarity between document segments by using vectors, each of which has the weights of the terms in the document as the components; the sentence extraction unit implements extraction based on the importance of the sentence in the structural segment and the importance of the structural segment.

Furthermore, the aided authoring apparatus 300 may further comprise: a term weight calculation unit for calculating the weight of each term in the structural segment based on the occurrence frequencies of said term in the structural segment and the number of sentences in which the term occurs within said structural segment; and a topic weight calculation unit for calculating the weight of each topic term in said topic based on the occurrence frequency of said topic term in said document and the number of sentences in which the topic term is contained.

Above-described aided authoring apparatus of the present embodiment may operationally implement the method of computer aided authoring described in above embodiments. The apparatus may assist the writer to complete the preparation of a structure summary without bringing too much burden to the writer. The understanding of the writer to the document can be utilized to ensure the accuracy and readability of the structure summary generated, and because the generated structure summary can reflect the contents of respective parts of the document, when the structure summary information is used for previewing, the user can find out the content of the document more accurately and completely, so that high degree of user satisfaction can be obtained.

Electronic Document Browser

Under the same inventive conception, according to another aspect of the present invention, there is provided an electronic document browser, the electronic document browsed is prepared by the above described method of computer aided authoring, that is, the structure summary information has been saved in correspondence with the document.

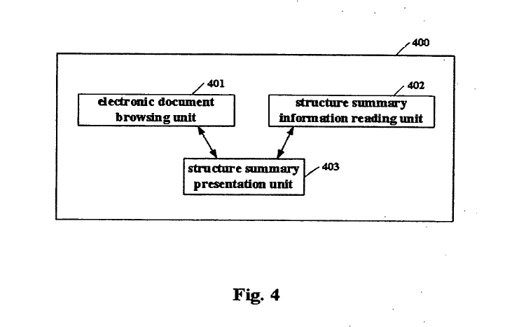

FIG. 4 is a block diagram illustrating the structure of an electronic document browser according to an embodiment of the present invention. As shown in FIG. 4, the electronic document browser 400 of the present embodiment comprises: an electronic document browsing unit 401 for browsing the content of an electronic document, which can be a browser of the prior art, such as MS Word Viewer, MS Internet Explorer, Netscape Navigator, Acrobat Reader or the like;
a structure summary information reading unit 402 for reading structure summary information saved in correspondence with said electronic document, particularly, the structure summary information is read out according to the way of saving the structure summary information, for instance, if the structure summary information is saves at the end of the document as a knowledge tag, then the knowledge tag is identified and the information in the tag is read out correspondingly; and
a structure summary presentation unit 403 for presenting the structure summaries contained in the structure summary information read out by the structure summary information reading unit 402 to the user, particularly, the structure summary can be presented to the user for browsing, for instance, through an operation, such as clicking a menu or button.

From the above-description of the present embodiment it can be seen that, the electronic document browser of the present embodiment may operationally implement the above-described method for browsing an electronic document of the present invention, by using the structure summary information in an electronic document composed with the above mentioned method for aided authoring to present the reader with the structure summaries verified by the writer, so that the reader can have an overview of content of the document, whereby saving the reader's time for reading.

Above described apparatus for aided authoring, electronic document browser as well as their respective components may be implemented in the form of hardware and software, and may be combined with other apparatus according to requirements, such as, they may be implemented on a personal computer, a notebook computer, a palm, a PDA, a word processor and other devices having computation functionality, and their functions can be performed on the basis of physically separated from each other and operably connected to each other.

Though a method for computer aided authoring, a method for browsing an electronic document, an apparatus for aided authoring and an electronic document browser of the present invention have been described in details with some exemplary embodiments, these embodiments are not exhaustive. Those skilled in the art may make various variations and modifications within the spirit and scope of the present invention. Therefore, the present invention is not limited to these embodiments; rather, the scope of the present invention is only defined by the appended claims.

Variations described for the present invention can be realized in any combination desirable for each particular application. Thus particular limitations, and/or embodiment enhancements described herein, which may have particular advantages to a particular application need not be used for all applications. Also, not all limitations need be implemented in methods, systems and/or apparatus including one or more concepts of the present invention.

The present invention can be realized in hardware, software, or a combination of hardware and software. A visualization tool according to the present invention can be realized in a centralized fashion in one computer system, or in a distributed fashion where different elements are spread across several interconnected computer systems. Any kind of computer system—or other apparatus adapted for carrying out the methods and/or functions described herein—is suitable. A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which—when loaded in a computer system—is able to carry out these methods.

Computer program means or computer program in the present context include any expression, in any language, code or notation, of a set of instructions intended to cause a system having an information processing capability to perform a particular function either directly or after conversion to another language, code or notation, and/or reproduction in a different material form.

Thus the invention includes an article of manufacture which comprises a computer usable medium having computer readable program code means embodied therein for causing a function described above. The computer readable program code means in the article of manufacture comprises computer readable program code means for causing a computer to effect the steps of a method of this invention. Similarly, the present invention may be implemented as a computer program product comprising a computer usable medium having computer readable program code means embodied therein for causing a function described above. The computer readable program code means in the computer program product comprising computer readable program code means for causing a computer to effect one or more functions of this invention. Furthermore, the present invention may be implemented as a program storage device readable by machine, tangibly embodying a program of instructions executable by the machine to perform method steps for causing one or more functions of this invention.

It is noted that the foregoing has outlined some of the more pertinent objects and embodiments of the present invention. This invention may be used for many applications. Thus, although the description is made for particular arrangements and methods; the intent and concept of the invention is suitable and applicable to other arrangements and applications. It will be clear to those skilled in the art that modifications to the disclosed embodiments can be effected without departing from the spirit and scope of the invention. The described embodiments ought to be construed to be merely illustrative of some of the more prominent features and applications of the invention. Other beneficial results can be realized by applying the disclosed invention in a different manner or modifying the invention in ways known to those familiar with the art.

1. A method for computer aided authoring comprising:
when a writer is writing an electronic document, generating a structure summary based on said electronic document; and
saving said structure summary information in correspondence with said electronic document.

2. The method for computer aided authoring according to claim 1, wherein said step of generating a structure summary comprises:
dividing said document into one or more structural segments, each of said structural segment being related to a topic; and
extracting one or more sentences from each structural segment, respectively, as the structure summary.

3. The method for computer aided authoring according to claim 2, wherein said step of dividing said document into one or more structural segments comprises:
selecting a document segment as a seed segment;
calculating the similarities between said seed segment and subsequent document segments;
selecting one or more document segments having high similarities to said subsequent document segments, together with said seed segment, as one structural segment; and
taking a document segment immediately following the structural segment as the seed segment and repeating the above steps of calculating and selecting.

4. The method for computer aided authoring according to claim 3, wherein said step of calculating the similarities between said seed segment and the subsequent document segments comprises:
calculating the weight of each term in said seed segment and the subsequent document segments;
representing each of said seed segment and the subsequent document segments by a vector with the weights of the terms as the components, respectively; and
calculating the similarities between said seed segment and the subsequent document segments by using their vectors.

5. The method for computer aided authoring according to claim 4, wherein said step of calculating the weight of each term in said seed segment and the subsequent document segments comprises:
according to the occurrence frequencies of said each term in said document segment and in said document, the number of the document segments in which the term is contained, calculating the weight of said each term.

6. The method for computer aided authoring according to claim 4, wherein said step of calculating the similarities between said seed segment and the subsequent document segments, comprises:
calculating the cosines of the angles between the vector of said seed segment and the vectors of the subsequent document segments as a measure of similarity.

7. The method for computer aided authoring according to claim 3, wherein said step of selecting one or more document segments having high similarities to said subsequent document segments together with said seed segment as one structural segment, further selects document segments between said document segment having high similarity and said seed segment as a part of the structural segment.

8. The method for computer aided authoring according to claim 3, further comprising a step of allowing the writer to verify the generated structural segment.

9. The method for computer aided authoring according to claim 2, wherein said step of extracting one or more sentences from each said structural segment as the structure summary comprises:
according to the occurrence frequencies of each said term in said structural segment and the number of sentences, in which said term is contained, in said structural segment, calculating the weight of each said term in said structural segment;
according to the weight of said term, calculating the importance of each sentence in said document; and
according to the importance of each sentence, selecting one or more sentences for each said structural segment.

10. The method for computer aided authoring according to claim 9, wherein said step of extracting one or more sentences from each structural segment as the structure summary further comprises:
according to the occurrence frequencies of the topic terms of each said topic in said document and the number of sentences, in which said topic term is contained, in said document, calculating the weights of said terms; and
according to the weights of the terms of each said topic, calculating the weight of each said topic,
wherein the step of selecting one or more sentences for each said structural segment comprises: selecting one or more sentences in conjunction with the importance of each sentence and the weight of the topic corresponding to the structural segment which contains the sentence.

11. The method for computer aided authoring according to claim 1, wherein said step of saving said structure summary information in correspondence with said electronic document comprises:
saving said structure summary information in said electronic document as a knowledge tag.

12. The method for computer aided authoring according to claim 1, wherein said step of saving said structure summary information in correspondence with said electronic document comprises:
saving said structure summary information as a file associated with said electronic document.

13. The method for computer aided authoring according to claim 1, further comprising:
after the generation of said structure summary, allowing the writer to verify said structure summary.

14. A method for browsing an electronic document, comprising:
reading structure summary information saved in correspondence with the electronic document, said structure summary information contains the structure summary of the electronic document; and
presenting said structure summary to a user, in response to the user's operation.

15. An apparatus for aided authoring, comprising:
an electronic document editor for editing an electronic document;
a summary generation unit for generating a structure summary according to said electronic document; and
a summary saving unit for saving the structure summary information generated by said summary generation unit in correspondence with said electronic document.

16. The apparatus for aided authoring according to claim 15, wherein said apparatus further comprises:
a summary evaluation unit for allowing the writer to evaluate and modify the structure summary generated by said summary generation unit.

17. The apparatus for aided authoring according to claim 15, wherein said summary generation unit comprises:
a structural segment dividing unit for dividing said document into one or more structural segments, each said structural segment relates to a topic; and
a sentence extraction unit for extracting one or more sentences from each said structural segment divided by said structural segment dividing unit, respectively, to form a structure summary.

18. The apparatus for aided authoring according to claim 17, wherein said apparatus further comprises: similarity calculation means for calculating the similarity between document segments;
wherein said structural segment dividing unit uses said similarity calculation means to calculate the similarities between document segments, thereby selecting one or more document segments having high similarity as one structural segment.

19. The apparatus for aided authoring according to claim 17, wherein said similarity calculation means calculates the similarity between document segments by using vectors having the terms in the document as components.

20. The apparatus for aided authoring according to claim 17, wherein said sentence extraction unit extracts sentences according to the importance of the sentences in the structural segment and the importance of the structural segment.

21. The apparatus for aided authoring according to claim 17, wherein said apparatus further comprises:
a term weight calculation unit for calculating the weight of each term in said structural segment according to the occurrence frequency of said term in the structural segment and the number of sentences in which the term is contained within said structural segment; and
a topic weight calculation unit for calculating the weight of each topic term in said topic according to the occurrence frequency of said topic term in said document and the number of sentences in which the topic term is contained.

22. An electronic document browser, characterized by comprising:
a structure summary reading unit for reading structure summary information saved in correspondence with said electronic document being browsed, said structure summary information contains the structure summary of the electronic document; and
a structure summary presentation unit for presenting the structure summary contained in said structure summary information to a user.

23. An article of manufacture comprising a computer usable medium having computer readable program code means embodied therein for causing computer aided authoring, the computer readable program code means in said article of manufacture comprising computer readable program code means for causing a computer to effect the steps of claim 1.

24. A computer program product comprising a computer usable medium having computer readable program code means embodied therein for causing aided authoring, the computer readable program code means in said computer program product comprising computer readable program code means for causing a computer to effect the functions of claim 15.

25. An article of manufacture comprising a computer usable medium having computer readable program code means embodied therein for causing electronic document browsing, the computer readable program code means in said article of manufacture comprising computer readable program code means for causing a computer to effect the steps of claim 14.

26. A computer program product comprising a computer usable medium having computer readable program code means embodied therein for causing functions of an electronic document browser, the computer readable program code means in said computer program product comprising computer readable program code means for causing a computer to effect the functions of claim 22.
